(19) United States
(12) Patent Application Publication
(10) Pub. No.: US 2010/0147728 A1
(43) Pub. Date: Jun. 17, 2010

(54) ENERGY ABSORBING APPARATUS FOR SHIPPING CONTAINER

(76) Inventors: Melvin Guiles, Grand Haven, MI (US); Todd Armstrong, Grand Haven, MI (US); Richard D. Heinz, Grand Haven, MI (US); James H. Dodd, Grand Haven, MI (US); Kenneth E. McKeller, Jension, MI (US); David Michael Sims, Houston, TX (US); Michael Shane Sims, Cypress, TX (US); Donald Patrick Reilly, Houston, TX (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 12/638,412

(22) Filed: Dec. 15, 2009

Related U.S. Application Data
(60) Provisional application No. 61/138,351, filed on Dec. 17, 2008.
(60) Provisional application No. 61/185,403, filed on Jun. 9, 2009.

(51) Int. Cl. B65D 81/02; B65D 88/00; B23P 11/00; B23P 19/00

(52) U.S. Cl. 206/521; 220/1.5; 29/428; 29/426.1

(57) ABSTRACT

An energy-absorbing bulkhead apparatus includes high-strength roll formed tubular bars, and a bar-supporting sheet to distribute stress from product shifting in large shipping containers during transport. Parts are re-useable and can be quickly installed into the shipping container at selected locations such as near the container's doors. The bars can be swept and/or have deformed/configured ends shaped to engage channel features in side walls of the large shipping container. The bars may define spaced tubes and a tie rod for added strength. For example, the bars can be steel having 120 KSI to 220 KSI tensile strength, and have a cross-section 2-3 inches in depth and 4-6 inches in height, a length of 94 long, and a longitudinal sweep of 6 inches curvature. A flexitank can be positioned in the shipping container and supported by a combination of the bulkhead.

### CROSS-REFERENCE TO RELATED APPLICATIONS

This application claims benefit under 35 U.S.C. §119(e) of provisional application Ser. No. 61/138,351, Dec. 17, 2008, entitled: ENERGY ABSORBING APPARATUS FOR SHIPPING CONTAINER, and also of provisional application Ser. No. 61/185,403, filed Jun. 9, 2009, entitled: ENERGY ABSORBING APPARATUS FOR SHIPPING CONTAINER, both having a common assignee Shape Corporation.

### BACKGROUND

The present invention relates to an energy absorber apparatus for shipping containers, and more particularly to an energy absorbing bulkhead used in large containers for transporting bulk product on boats, ships, trains, trucks, and aircraft.

Large shipping containers are often used for bulk product shipped on ships, boats, trains, trucks and aircraft. For example, see Grogan U.S. Pat. No. 5,141,122. These containers are designed to withstand significant impact loads and stress that may occur during loading and transport, including impacts from adjacent containers and also from product shifting internally during transport. The door-located end of containers is often problematic, because it is difficult to make a door and door-supporting structure “strong enough” to withstand impact without also adding excessive cost and weight to the container. Damage to doors can result in constant maintenance and expense. For example, when sorting railroad cars in a rail yard, the cars may encounter substantial jarring and high impact loads in excess of 75,000 pounds force as the railroad cars are rolled into one another for reconnection. Also, wave action can cause large ships to roll and tilt, resulting in product shifting during transport, and resulting in substantial stress on and/or damage to a container, including its doors.

Temporary structures (i.e., bulkheads) are often built within containers to keep product from shifting. These structures are built out of a variety of different products, such as wood, metal, plastic, and sheet material. They can include padding and/or other stress-distributing member(s). However, such temporary structures are often “custom” installations that take significant time and labor to construct. As a result, they are inefficient to construct, unreliable in strength, often are not as strong as desired, and often result in considerable waste since their materials are often damaged or destroyed when removed such that they cannot be reused. Further, they often lack simplicity of components and interconnecting structure.

Sometimes, liquids and flowable materials are shipped in the large rectangular shipping containers, with the liquids being contained by liquid-tight containers, such as barrels, drums and/or tanks. Aside from the risk of these liquid-tight containers shifting, the liquids and flowable materials themselves can wash and flow laterally in response to lateral-forces during shipment, adding to peak lateral forces during transport. Notably, there is a load limit on liquid products that can be carried within a given shipping container, such that the liquids often do not fill their respective liquid-tight containers, which lets the liquids build up momentum as they wash and ebb and flow laterally. Thus, there is an additional risk where liquid product itself shifts, aggravating the problem by adding to peak stresses and cyclical lateral impact loads.

Tanks in particular can be sensitive to the forces caused by liquids washing and flowing laterally within them. Specifically, as tanks are shaped to more closely fit within a rectangular shipping container, their side walls become flatter, making them more prone to bulging outward when they are filled. The side walls bulge outward even farther when their internal liquid washes and/or flows laterally due to side forces and movement during shipment. This can be problematic at the door-end of shipping containers, because the side walls can press against the container's doors. As noted above, the size of these impact loads is very difficult to gauge, but often can exceed 75,000 pounds force. A flexitank is a style of tank that is particularly prone to take on the shape of the container it is placed within, and thus is particularly prone to put pressure against container doors unless adequately supported. For example, see the “BIG RED™ FLEXITANK” made by Environmental Packaging Technologies, of Houston, Tex., which is made of flexible sheet material requiring support.

### SUMMARY OF THE PRESENT INVENTION

In one aspect of the present invention, a bulkhead apparatus is provided for a large shipping container where the shipping container includes container side walls defining an access opening and at least one door for closing the access opening, the side walls including opposing channel features positioned a known distance apart. The bulkhead apparatus includes at least one prefabricated section including at least one bar having a longitudinal curvature and further having ends corresponding to the known distance apart and configured so that the ends fit into the opposing channel features with a center of the at least one bar spaced away from the container door.

In another aspect of the present invention, an energy-absorbing bulkhead apparatus is provided for use in a shipping container, where the shipping container includes container side walls defining an access opening and opposing channel features, at least one door for closing the access opening, and framework on an end of the side walls adjacent the access opening. The bulkhead apparatus includes a plurality of metal tubular bars with configured ends shaped to matably engage the opposing channel features, the configured ends having a first cross-sectional shape different than a second cross-sectional shape in a center of the bars, the bars being arranged horizontally between the side walls and defining a vertical plane to form a bulkhead that prevents shipped materials from unacceptably shifting into the at least one door.

In another aspect of the present invention, a method of constructing an energy absorber bulkhead within a shipping container includes providing a plurality of removable tubular bars, each having one of configured ends and a swept center portion; and attaching the bars to the shipping container by placing ends of the bars into mating channel features in the side walls of the shipping container in an arrangement where the bars extend horizontally in a vertically stacked arrangement that forms a temporary structure that prevents product from unacceptably shifting against a container door.

In another aspect of the present invention, a method of constructing a temporary bulkhead in a container includes preforming at least one section including a structural bar of metal; supporting ends of the at least one bar across a door-adjacent end of a container to form a bulkhead preventing product from shifting against the door during shipment; dismantling the bulkhead; and later reusing the at least one section in another container.

These and other aspects, objects, and features of the present invention will be understood and appreciated by those skilled in the art upon studying the following specification, claims, and appended drawings.

### BRIEF DESCRIPTION OF DRAWINGS

FIG. 1 is a perspective view of the door-containing end of a shipping container for moving bulk product, the container including two opposing doors over its access opening.

FIG. 2 is an exploded view of FIG. 1, with the container's roof exploded away and showing a liner and a flexitank, and also showing three different temporary energy-absorbing bulkheads (also called “energy absorbing apparatus”), each being designed to absorb energy and prevent product shifting against the container's doors.

FIGS. 3-4 are perspective fragmentary views of a rear of the container in FIG. 1, with one door open and the other door removed for clarity, FIG. 3 showing a first version of temporary energy-absorbing bulkhead from FIG. 2 which includes opposing container-sidewall-engaging brackets and one wall section in place and additional sections ready for placement, FIG. 4 showing all sections in place on the brackets.

FIGS. 5-6 are top views taken along line IV in FIG. 3, FIG. 5 showing relative positions of the container-sidewall-engaging bracket and an associated section prior to insertion of the section, and FIG. 6 showing the relative positions after insertion and when the tank is pressing against the sections and, in turn, on the brackets.

FIGS. 7-10 are perspective front, perspective rear, front, and top views of the container-sidewall-engaging brackets of FIG. 5.

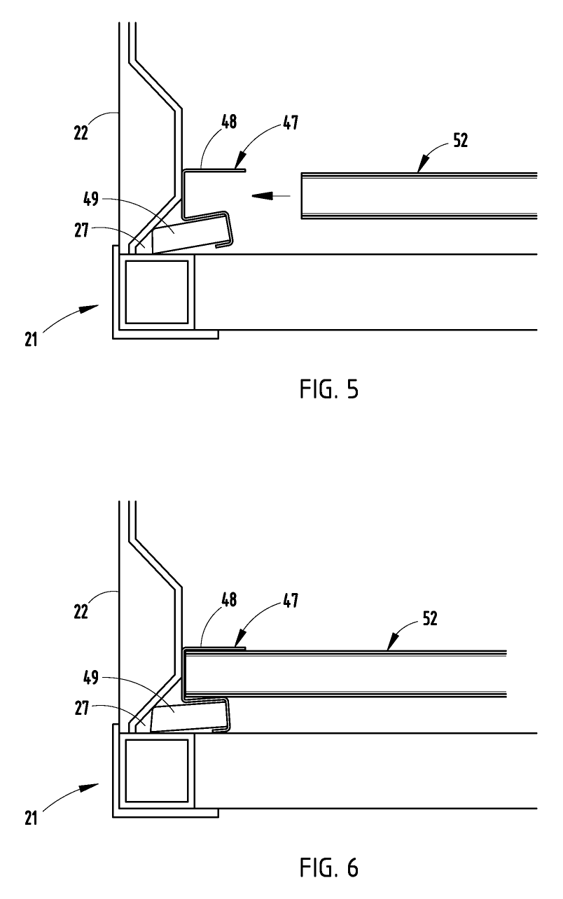

FIGS. 11-13 are views of the wall section shown in FIG. 3, FIG. 11 being a perspective view, FIG. 12 being an exploded view, and FIG. 13 being an end view.

FIG. 14 is an end view of the container in FIG. 4, and FIG. 14A is a view of the stacked sections without the container.

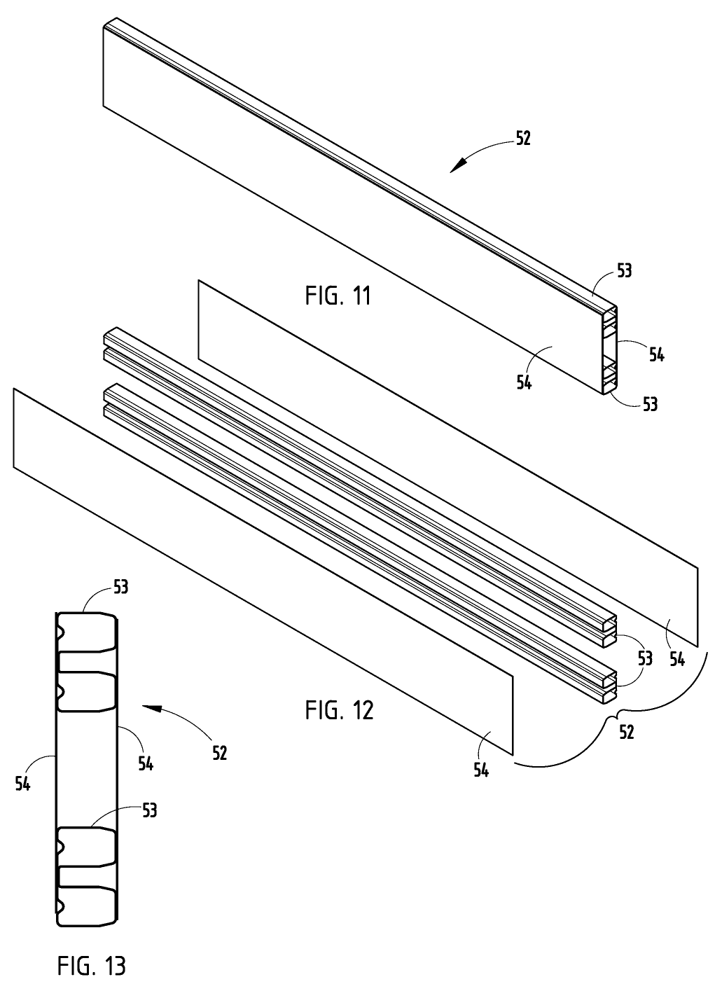

FIGS. 15-16 are perspective views of the container in FIG. 2, FIG. 15 showing a second version of temporary energy-absorbing bulkhead from FIG. 2 which includes multi-curved bars and a bar-engaging sheet holder with one bar in place, FIG. 16 showing all bars in place.

FIG. 17 is a cross-section along line XVII-XVII in FIG. 16 showing corner support for the flexitank.

FIG. 18 is an end view of FIG. 16, and FIG. 18A is a view of the stacked bars and sheet holder alone (with the container removed).

FIG. 19 is a perspective view similar to FIG. 16, but with bars that are continuously longitudinally swept and having flattened configured ends shaped to fit into mating channels in the door frame structure on the container, the bars including tie rods connecting their ends for added strength.

FIG. 20 is a perspective view from an inside of the container looking at the bars and temporary energy-absorbing bulkhead in FIG. 19.

FIG. 21 is an exploded perspective view of one of the bars from FIG. 19.

FIGS. 22-24 are top, front, and transverse cross-section of the double-tube bar of FIG. 19, and FIG. 25 is an enlarged top view of the end of one such bar.

FIGS. 26-27 are perspective and top views of a single tube bar similar to the bar in FIG. 21 but defining only a single tube, and FIG. 28 is a transverse cross-section through same to illustrate its cross-sectional shape.

### DETAILED DESCRIPTION OF PREFERRED EMBODIMENTS

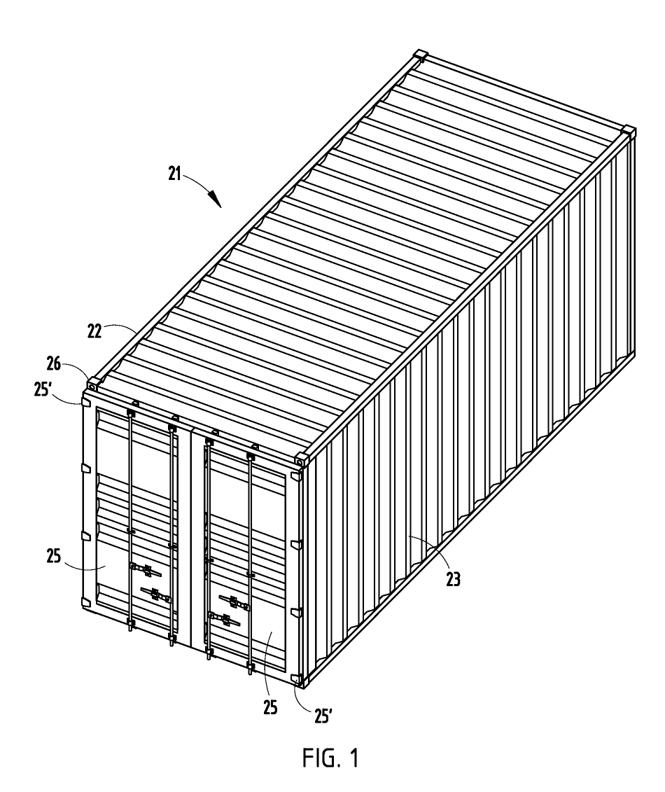

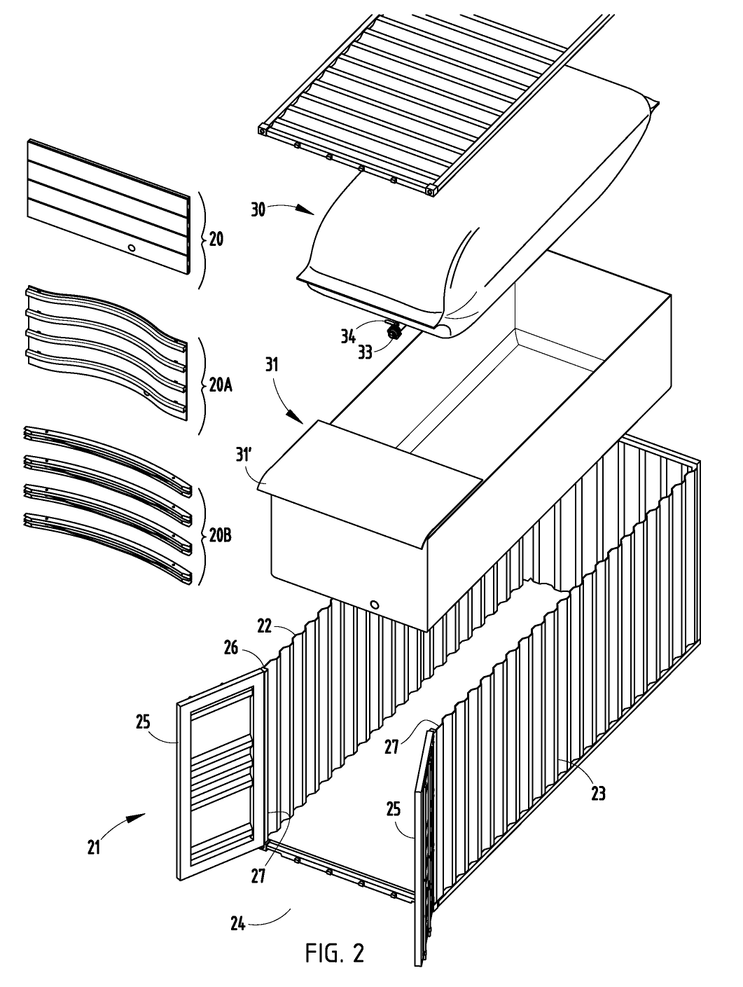

A shipping container 21 (FIG. 1) for shipping bulk product includes container side walls 22 and 23 defining with its roof and floor an access opening 24 (i.e., door-supporting end), at least one door 25 (two doors being illustrated) supporting on hinges 25′ for closing the access opening 24, and a framework 26 (also called “header”) on an end of the side walls 22 and 23 adjacent the access opening 24 supporting the doors 25. The framework 26 forms channel features 27 in the sidewalls 22, 23 adjacent the opening 24 and along the side walls 22 and 23. A bulkhead is formed within the container 21 as illustrated in FIG. 2.

FIG. 2 illustrates a flexitank 30 (such as “BIG RED™ FLEXITANK” made by Environmental Packaging Technologies, Houston Tex.), and a liner 31 for supporting the walls of tank 30 against the container side walls 22, 23. In such case, an energy-absorbing apparatus 20 (called “bulkhead” hereafter) is required to prevent the end of the flexitank 30 from flexing and pressing against the doors 25. Three different energy-absorbing bulkheads 20, 20A, 20B are illustrated in FIG. 2. Notably, even though a Flexitank™ is illustrated in FIG. 2, it is contemplated that the temporary energy-absorbing bulkhead can be used to prevent other product from shifting during transport, such as barrels of liquid product (shrink wrapped or not), pallets of liquid or non-liquid product, individually placed product, flat-sided tanks (metal or plastic), round-sided tanks, and the like. The illustrated flexitank 30 includes a fill tube 33 with shut-off valve 34.

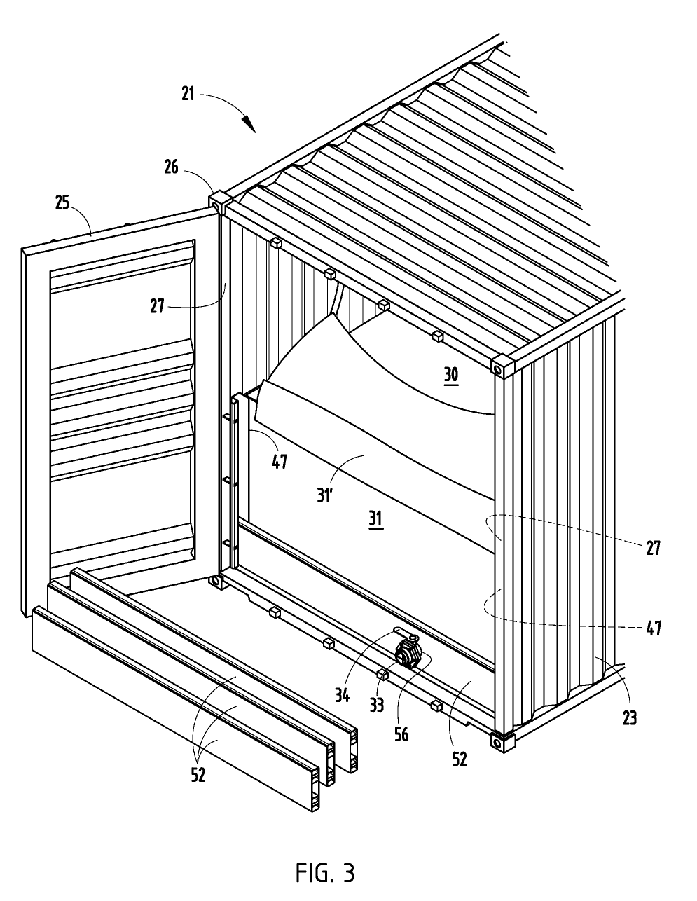

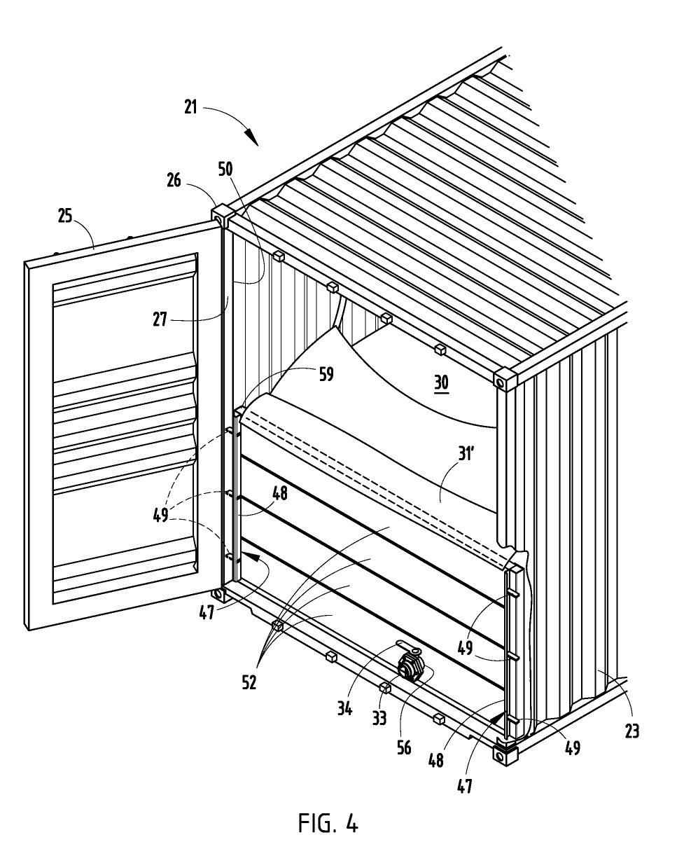

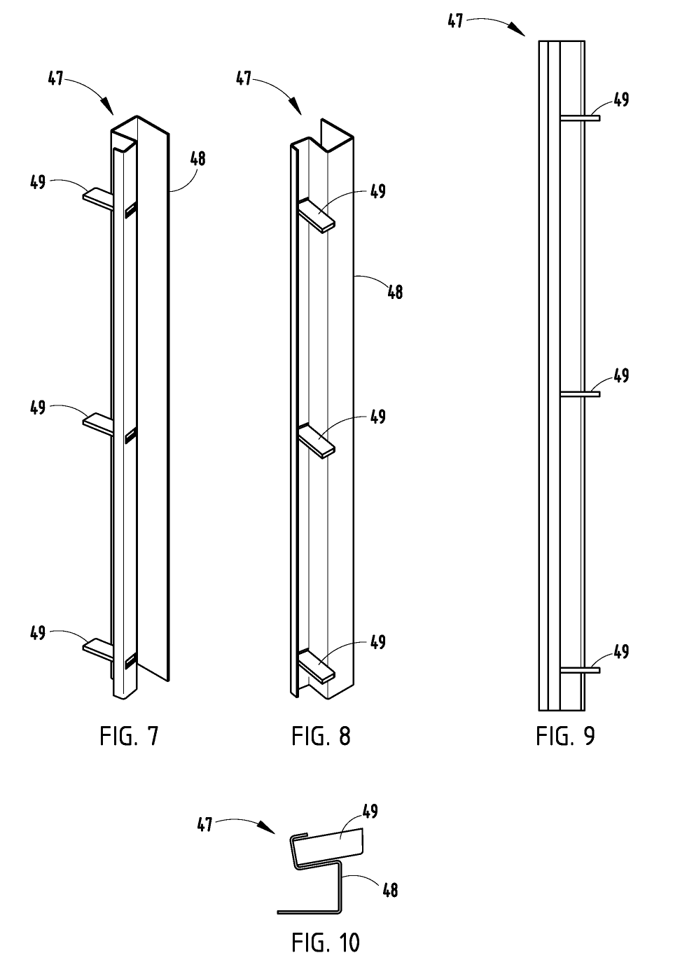

The energy absorbing bulkhead 20 (FIGS. 3-4) includes brackets 47 (see FIGS. 11-13) having an elongated Z-shaped component 48 and three (or more) structural horizontal finger-like projections 49 configured to releaseably engage a mating channel-defining feature 27 (see FIGS. 5-6) on the framework 26 on each side of the access opening 24. The illustrated bulkhead 20 includes one or more wall-forming sections 52 (FIGS. 3 and 11-13), each having a pair of bars 53 (also called “structural tubular beams”) and opposing panels 54 of sheet metal attached to opposing sides of the bars 53. Each section 52 releasably fits into and extends between the brackets 47 and is configured to withstand impact loads of over 75,000 pounds, preventing the product from shifting against the doors 25 of the shipping container 21 during transport. In one form, the bars 53 of each section 52 are made of steel having a 120 KSI tensile strength and 1.2 mm thick, and are linear. However, it is also contemplated that the bars 53 (i.e., the sections 52) can be longitudinally-curved (i.e., “swept”) (as described below) so that energy from product shifting during transport is absorbed by bar flexure without moving too close to the doors 25, as described below.

The illustrated panels 54 are made of 80 KSI steel having 0.1875 inch ( 3/16″) thickness. The illustrated sections 52 are about 91⅜ inches long, about 16 inches high, and about 3 inches thick. However, it is contemplated that the wall sections 52 could be made thinner or thicker, such as 2 inches thick, and that a deeper longitudinal sweep can be added. In one form, the bars have cross-sectional dimensions of about 2 to 4 inches deep (horizontally) and about 3 to 6 inches high (vertically), with two bars being used per section 52. However, it is contemplated that in many applications cross-sectional dimensions will be at least about 2½ to 3 inches deep and about 3½ to 4¾ inches high. As noted, the bars 53 can have different sweeps and longitudinal curvatures.

The sections 52 (see FIGS. 3-4) can be stacked vertically, with each end of the sections 52 (i.e., the ends of the bars 53) engaging different vertical portions of the channel in the Z-shaped component 48. A lowest one of the sections 52 (FIG. 4) has aligned openings 56 in the lowermost panels 44 which align with a similar opening in the liner 31 to provide a through hole for the fill tube 33 with shut-off valve 34 on the liquid-filled flexitank 30. Notably, the illustrated fill tube 33 and valve 34 are sufficiently short to fit between the bulkhead 20 and the doors 25 when closed. It is also noted that when swept bars are used, there is additional room for the fill tube 33 and valve 34 between the wall and doors. The illustrated openings 56 (and fill tube and valve) are off set to permit filling liquid into the tank (and also draining the liquid from the tank) past the bulkhead 20 even when one of the doors 25 is closed. Notably, the brackets 47 (and/or the ends of the sections 52) can be made to mate with any of the channel features 27 in the side walls 22 and 23 of the container, such that the bulkhead 20 can be located anywhere along a length of the container.

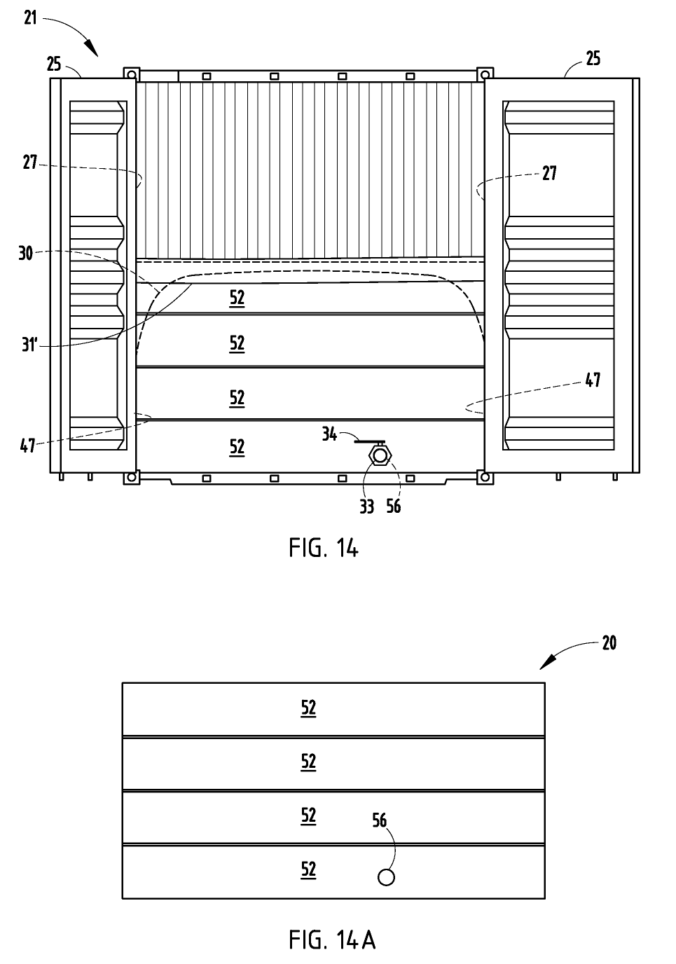

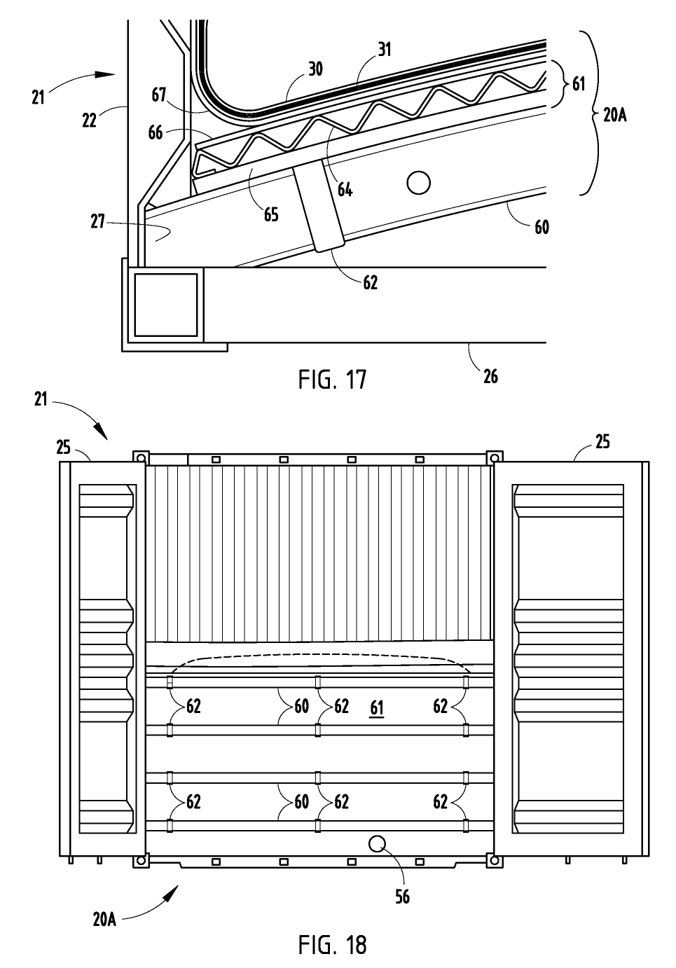

The illustrated bars 53 (FIGS. 11-13) are tubular, and have a B-shaped cross-section. Dimensions of the cross-section may vary for particular applications. It is contemplated that the bars 53 will have cross-sectional dimensions of at least about 2 inches (in a wall thickness direction) and 3 inches (in a cross-container direction), and in many applications cross-sectional dimensions of at least about 3 inches×3½ inches. The bars 53 and hence wall sections 52 can have different sweeps/longitudinal curvatures depending on particular functional requirements. For example, the bars in FIGS. 15 and 19 are longitudinally swept (i.e., curved longitudinally) to position their middle at least about 1 inch rearward (i.e., inward toward an interior of the tank) compared to ends of the bar. Notably, this “inboard bend” (i.e., sweep) in the bars can cause a middle of the bulkhead to be several inches rearward of the doors, the depth being dependent on the stress expected in a particular situation. This inboard bend/sweep allows the bulkhead 20 to flex and absorb energy prior to the wall section(s) 52 becoming “flat.” The illustrated energy-absorbing bulkhead 20 can absorb up to 140,000 pounds force. Clamps 59 (FIG. 4) can be used to secure a top one of the wall sections 52 in place on the brackets 47, if it is desirable to more securely hold the wall sections 52 in place (rather than to rely only on gravity hold them in place).

Reference is made to U.S. Pat. No. 5,092,512; U.S. Pat. No. 5,454,504; U.S. Pat. No. 7,530,249 and U.S. 2009/0255310, all assigned to Shape Corporation, the entire contents of each of which are incorporated herein in their entirety for the purpose of providing a complete and adequate disclosure of roll forming processes that can be for forming different bars.

The method of constructing the sections 52 includes roll forming the B-shaped tubular bars 53 (and if desired, also sweeping the bars 53 during or after roll forming). If necessary or desirable, ends of the sections 52 are reformed to fit into the brackets 47 (or to fit directly into the channel feature 27 in the container walls 22 and 23). A panel 54 is then attached to each of the opposing sides of a pair of the bars 53, by welding or other means. One method of constructing a tank-supporting energy absorber bulkhead 20 within a shipping container 21 includes placing the liner 31 vertically within the container 21, and then placing the tank 30 in the container 21. The brackets 47 are then positioned in channel features 27 on the framework 26 of the shipping container 21 (on each side of the access opening 24, or at another inside location within the container 21 along the side walls 22 and 23). The sections 52 are then manipulated into position and vertically slid downwardly in between the oppositely positioned brackets 47, with ends of the sections 52 engaging the brackets 47, and with the sections 52 extending across the container's access opening 24 in a location and height where they will prevent product from shifting during transport. Also, for flexitanks 30, the fill tube 33 and shutoff valve 34 are extended through the openings in the liner 31 and through the opening in the bottom section 52. A front lip 31′ on the liner 31 extends over a top of the bulkhead 20, which helps keep it in place until the tank 30 is filled. The method further includes removing all components of the bulkhead 20 and reusing them. Notably, the components of the present bulkhead 20 are relatively light-weight, such that they are a much lower percent of the overall product shipment's total weight. Further, “assembly” of a given bulkhead 20 can be accomplished relatively quickly, and without the need for special tooling or special installation skills.

As briefly noted above, it is contemplated that the present energy-absorbing bulkhead 20 can be constructed to be positioned anywhere along the sidewalls 22, 23 of the container 21. Thus, multiple bulkheads 20 can be used to hold individual “islands” of product material in their respective space within a container 21 in a manner preventing prevent undesired shifting of product within the container 21.

### Modification

An energy-absorbing bulkhead 20A (FIGS. 15-16) (also called “energy-absorbing apparatus”) is provided for use in a large modular rectangular shipping container 21 like that described above, with container side walls 22 and 23, an access opening 24, doors 25, and framework 26 adjacent the access opening 24. The energy-absorbing bulkhead 20A includes bars 60 (similar to bars 53) and a single bar-holding sheet 61 (also called a “reinforcement panel” or “stress-distributing vertical panel”) in front of the doors 25 as described below. The illustrated bar-holding sheet 61 comprises a single sheet that extends top to bottom of the bulkhead 20A. The illustrated sheet 61 includes Velcro® straps 62 for holding the bars 60 in place on the sheet holder 61 while the bulkhead 20A is “built”. However, it is contemplated that any quick-attach or drop-in bracket (see bracket 63 in FIG. 15 with down hooks for engaging slots in the vertical sheet 61) can be used for holding bars in place during construction of the bulkhead 20A. The sheet 61 has sufficient stiffness to hold the bars 60, and also the bars have ends shaped to fit into the channel feature 27 of the container 21 on either side of the access opening 24. A single sheet 61 is illustrated, but it is contemplated that multiple sheets 61 (in a thickness direction, or in a vertically stacked direction) can be used if desired, or that other sheet products can be used having a desired level of stiffness, toughness, softness, thickness, and energy-distributing properties.

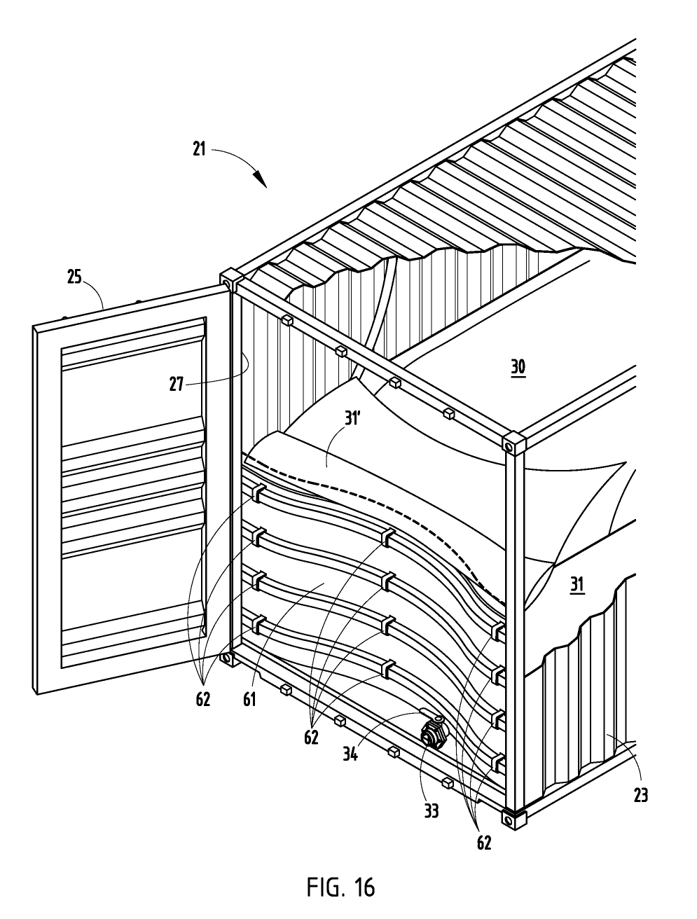

The illustrated bars 60 (FIGS. 15-16) define a single tube, and are about 2.8 inches deep by about 4.8 inches high, about 94¼ inch long, and have a rectangular or square cross-section along a majority of their length (with slightly rounded corners to facilitate roll forming the tubular bars). It is contemplated that dimensions of the cross-section can be varied for particular applications. For example, it is contemplated that the bars 60 for large shipping containers, when held in a container-mounted position, will have cross-sectional dimensions typically of about 2 to 4 inches deep/horizontally and about 3 to 6 inches high/vertically. In many applications, the bars more preferably have cross-sectional dimensions of at least about 2½ to 3 inches deep and about 3½ to 4¾ inches high. The bars 60 can have different sweeps/longitudinal curvatures depending on particular functional requirements of the bulkhead 20A. For example, FIGS. 15-16 show the bars 60 as having a center section swept along a first radius curvature, and having end sections reversely curved back to a position and orientation where they are co-linear with each other. The illustrated bars 60 have a mid point that is about 6 to 8 inches forward of end sections of the bar 60 (the bar being 94¼ inches long), which allows 6 to 8 inches of flexure and energy absorption prior to the bulkhead 20A becoming “flat.” Ends of the bars 60 can be deformed or configured to matably fit into the channel features 27 in the side walls 22 and 23 of the container. The illustrated energy-absorbing bulkhead 20A (FIGS. 15-18) is relatively easily installed, and can absorb over 140,000 pounds force.

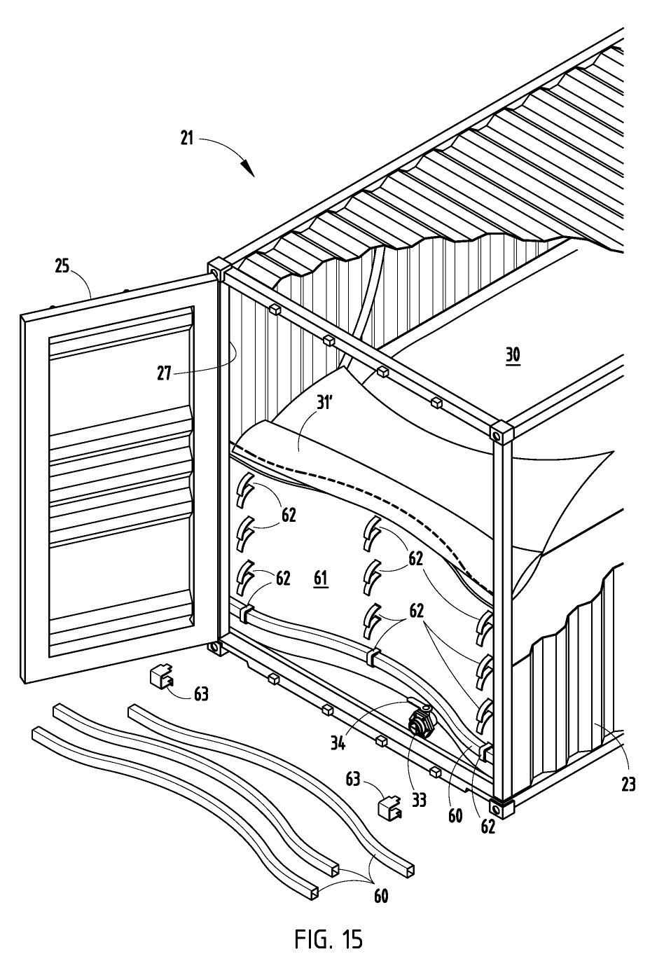

The bar-holding sheet 61 can be made of different materials and laminates. The illustrated sheet 61 (FIG. 17) includes an accordion folded inner sheet stiffener 64 and front and rear outer sheets 65 and 66 bonded to form a combined sheet having sufficient stiffness to hold the bars 60 until the tank is filled. The sheet 61 also to holds the bars 60 during transport, and further distributes stress against the tank 30. The sheet 61 may also include corner-forming sections 67 that provide additional stress-distributing properties to the corners of the tank to prevent ripping and tearing of the tank 30 at its corners due to undesirable stretching and stress that occurs at the corners when the tank is filled.

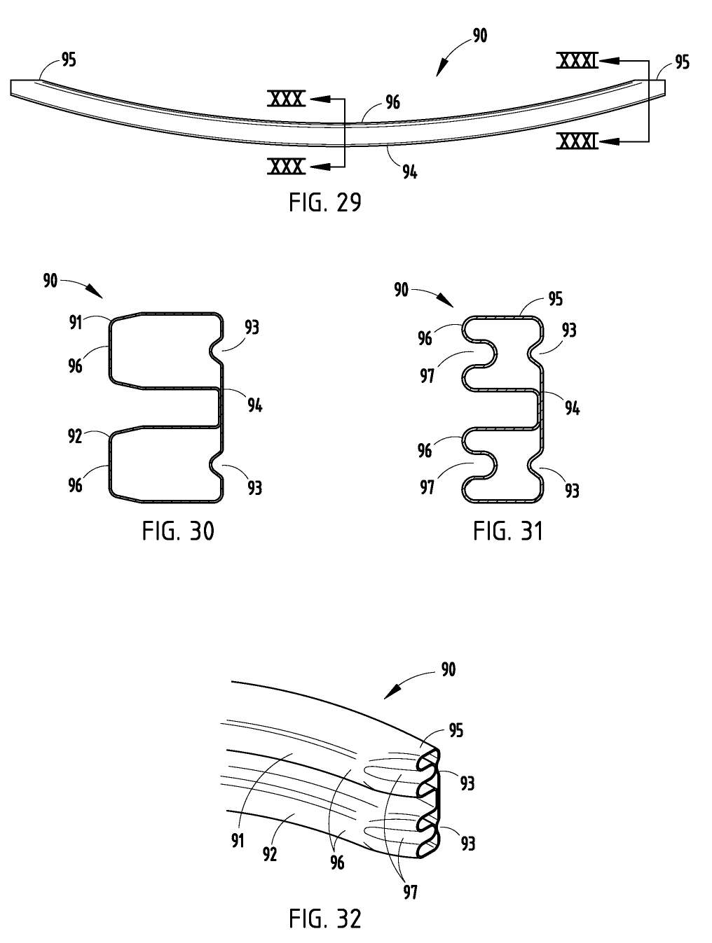

The illustrated energy-absorbing bulkhead 20B (FIGS. 19-21) is similar to bulkheads 20A and 20, but bulkhead 20B includes bars 70 (also sometimes called “structural tubular beams”) with ends 75 angle cut on one side to form co-planar “flat” rear mounting surfaces 76. (Alternatively, it is contemplated that a flat rear surface 76 can be formed by deforming an end of the bar (see FIGS. 29-32), and/or by angle cutting and then welding a flat plate onto an end of the bar (see FIGS. 26-28) to provide a desired surface profile.) As a result, the curved front surface 77 and the flat rear surface 76 combine at the end 75 to define a depth dimension 78 and shape that fits matably into the channel features 27 of the framework 26. By manipulating the bars 70 at an angle so that one end 75 is higher than the other, their ends 75 can be slid into position in the opposing channel features 27 as the bars 70 are brought to a flat position when forming the bulkhead 20B.

The bars 70 can be stacked directly on top of each other, with the side of each successive bar supporting the side of an adjacent bar. Alternatively, a bar-holding sheet 61 can be used. Alternatively, spacers can be used to space the bars 70 apart, if desired. For example, it is contemplated that the spacers can be attached to the bars 70 themselves, or can be separate parts positioned in the channel features 27 between the ends of adjacent bars 70. For example, it is contemplated that the spacers can be H shaped parts for engaging the bars 70 (inboard of the bar's ends), each having a downward throat engaging a lower bar 70, an upward throat engaging an adjacent upper bar 70, and a middle that is sufficient in length to space adjacent bars 70 vertically apart.

In one form, the bars 70 of the wall 20B are made of steel having at least 120 KSI tensile strength (or potentially 220 KSI tensile strength or more) and 1.2 mm thick (or potentially 0.8 mm thick or less). Also, the bars 70 can be swept (i.e., bowed longitudinally) several inches, such as 4-10 inches, so that energy from product shifting during transport is absorbed by bar flexure. The bars are preferably roll formed to have a constant tubular cross-section (or multi-tubular cross-section) along a majority of their length, and have ends modified as needed in secondary operations for engaging the container side walls.

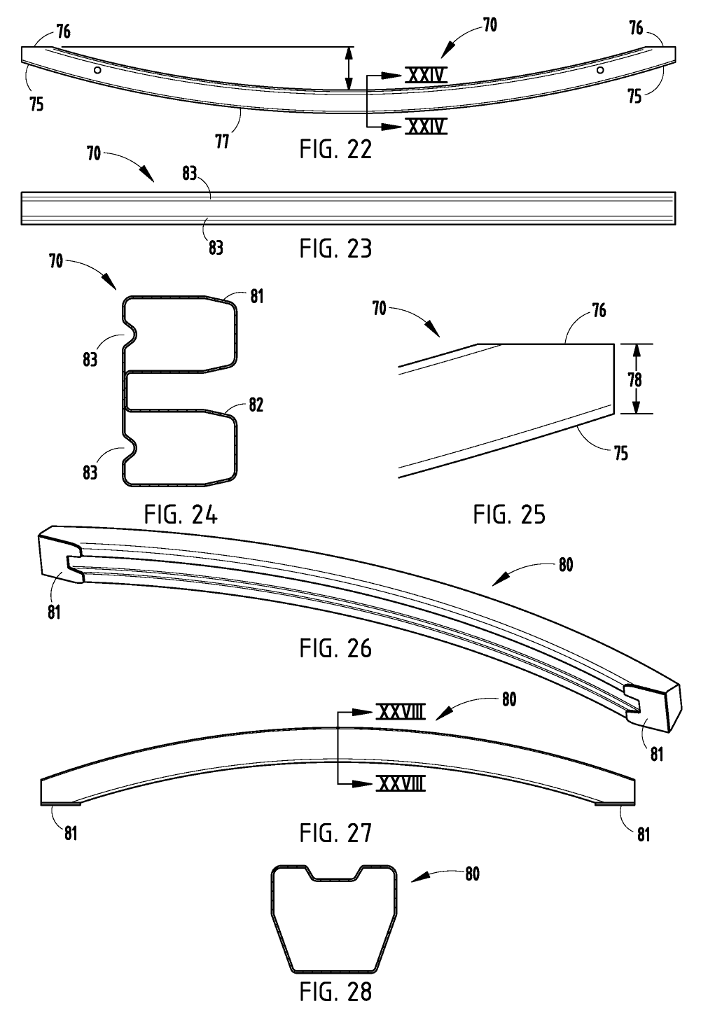

The illustrated bar 70 (FIGS. 22-25) is a B-shaped bar with spaced apart tubes 81 and 82, with a front wall of the bar having a channel rib 83 centered over each tube. It has been found that the illustrated cross-sectional shape of the illustrated bar 80 with channel rib over each tube can provide significant improved bending strength, making the actual bar bending strength much closer to the theoretical bar bending strength.

The illustrated bar 70 has its ends angle cut to form a flat co-planar rear mounting surfaces 76 that combine with the angled front surfaces to form a trapezoid shape at its configured ends well suited to matably engage the channel feature 27 in the container. Notably, the configured ends can be substantially any shape desired for mating engagement with the channel features of the large shipping container. It is noted that the configured ends of the bars can be made in different ways, depending on functional requirements of particular bulkheads. For example, a second bar 80 (FIGS. 26-28) is a single tube bar that could be used in place of bar 70. The bar 80 includes configured ends that are angle cut but then a flat plate is welded to form its flat engagement area on the door-remote side surface. By this construction, ends of the bars 80 are configured/shaped to optimally engage the channel feature 27 in the side walls 22 and 23 of the container. Alternatively, in place of the flat welded plate, it is contemplated that a molded spacer could be formed that fits onto the open end of the bar, the spacer being made of plastic material and creating a desired end shape. It is contemplated that this molded spacer could have a downwardly (or upwardly) formed protrusion configured to support an adjacent bar at a desired height/spacing.

FIGS. 29-32 illustrate a bar 90 similar to bar 70 in cross-section. Specifically, bar 90 includes spaced tubes 91 and 92 and channel ribs 93 in its door-remote (interior-positioned) wall 94 over each tube. However, at the ends 95, the door-adjacent wall 96 is deformed at locations 97 toward the interior wall 94 until it abuts the associated channel rib 93. This forms a configured end with trapezoidal shape similar to the ends of bars 70 and 80, and which is well suited to matably engage the channel features of the large shipping container 21.

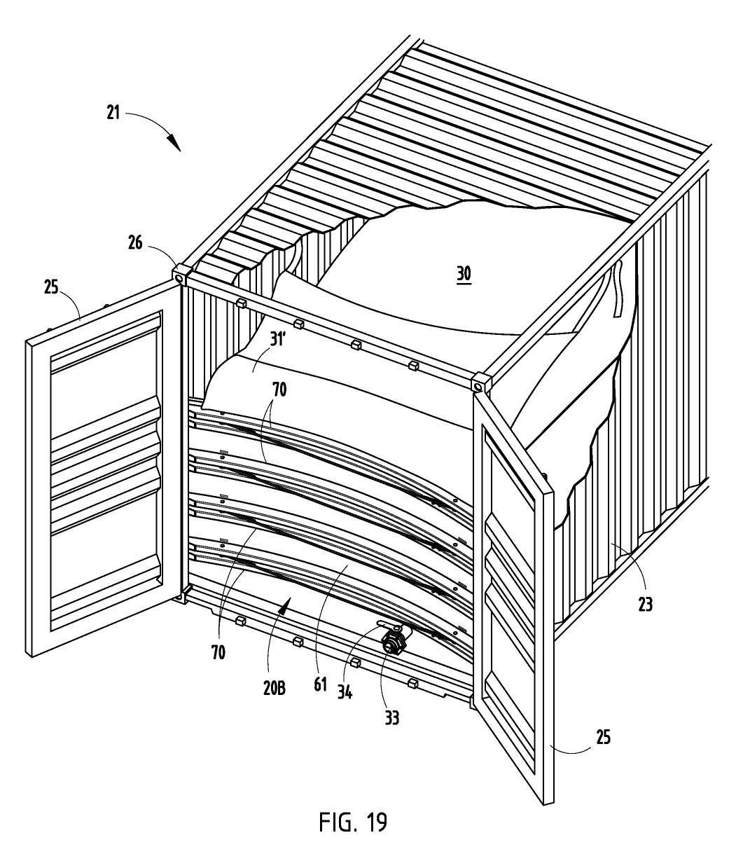

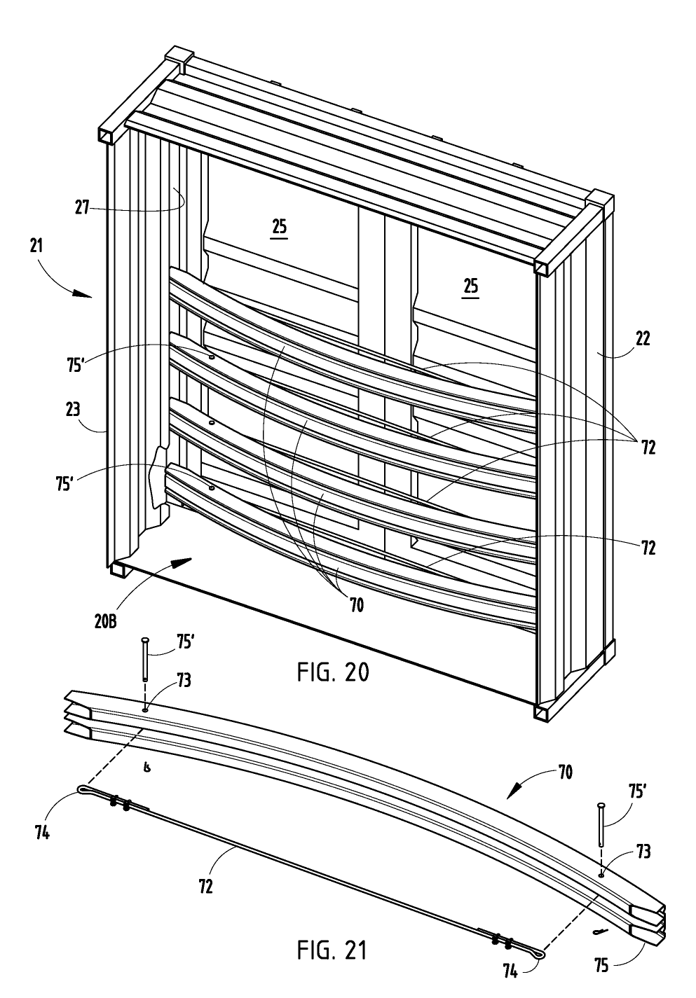

In curved bars, such as bar 70 in FIGS. 19-20 (or in bars 80 or 90), a tie rod 72 can be used to further strengthen the bar 70. For example, the illustrated bar 70 (FIG. 21) is B-shaped (i.e., includes top and bottom tubes spaced apart to define a channel) and includes holes 73 near each end. The tie rod 72 with loop ends 74 can be placed in the channel, with the loop ends 74 aligned with the holes 73. This allows a pin 75′ to be dropped through the holes 73 and through the loop ends 74 to lock the tie rod 72 in position. The pin 75′ can be secured in place by a cotter pin or spring clip if desired. When the bar 70 is stressed and flexed toward a straightened condition, the tie rod 72 tensions, thus helping to hold the bar 70 in its curved condition.

It is contemplated that a scope of the present inventive concepts are sufficiently broad to include bars having many different cross-sectional shapes, including open-channel bar shapes, such as a C channel shape, or an I bar shape, or a Z channel shape.

The present bulkheads are particularly advantageous when used with flexitanks, since the sheet walls of these tanks are very flexible and require support to avoid pressing on container doors. Specifically, flexitanks allow a maximum amount of liquid material to be transported within a container 21, such as 16,000 to 24,000 liters in a typical large rectangular shipping container, since they take up a minimal amount of space within the container and further since the flexitank generally expands to a shape defined by the container. Also, they minimize the amount of packaging materials and simultaneously minimize waste. (I.e., A greater amount of the weight shipped is actual liquid product, and also less packaging must be thrown away at the final destination.) Also, the flexitank and its liner typically can be made of recyclable materials and of lower cost materials, making the overall shipping system much more environmentally friendly than existing systems. Contrastingly, barrels and/or most other shipping containers must be disposed of (which is expensive and not environmentally friendly) or reused (which is difficult to do without cross contamination from earlier shipped materials and also which can require clean-out processes that are expensive and environmentally unfriendly). However, flexitanks require a secure and stable bulkhead, such as anyone of the illustrated bulkheads 20, 20A, 20B, which makes their combination with these bulkheads particularly advantageous.

The above-illustrated bars are preferably roll formed tubular beams made from sheet metal of desired strength and thickness, and welded into a permanent shape. The bars include one or more tubes, and have a cross-section for optimal bending strength. The bars preferably provide a flat surface on their door-remote side for engaging the vertical panel which in turn supports the product containers or tanks within the large shipping containers. The bars can be made to have a predetermined longitudinal sweep that increases a safety zone around the container's doors. The sweep can be made during the roll forming process or thereafter in a secondary operation. A vertical panel can be placed inside the bars to further provide stress distribution against product shifting during transport, the panel being constructed for optimal strength, low weight, softness and also toughness/stiffness. In some forms, the panel includes bar-retainers, such as Velcro™ straps to hold the bars at selected spaced-apart heights.

It is to be understood that variations and modifications can be made on the aforementioned structure without departing from the concepts of the present invention, and further it is to be understood that such concepts are intended to be covered by the following claims unless these claims by their language expressly state otherwise.

The embodiments of the invention in which an exclusive property or privilege is claimed are defined as follows:

1. In a large shipping container including container side walls defining an access opening and at least one door for closing the access opening, the side walls including opposing channel features positioned a known distance apart, an improved bulkhead apparatus comprising:
at least one prefabricated section including at least one bar having a longitudinal curvature and further having ends corresponding to the known distance apart and configured so that the ends fit into the opposing channel features with a center of the at least one bar spaced away from the at least one door.

2. The apparatus defined in claim 1, wherein the at least one metal bar includes at least two horizontal bars per cross-section.

3. The apparatus defined in claim 1, wherein the at least one bar includes end sections that are co-linear and aligned.

4. The apparatus defined in claim 1, wherein the sections each include a panel supported against front and rear sides of the at least one bar.

5. The apparatus defined in claim 1, wherein the sections each include, on at least one side of the bar, a panel including at least one flat sheet and a corrugated inner sheet supporting on the flat sheet.

6. The apparatus defined in claim 1, wherein the at least one section includes at least three sections are stacked vertically.

7. The apparatus defined in claim 1, wherein the at least one bar includes at least one tube section.

8. The apparatus defined in claim 7, wherein the at least one bar includes at least two spaced-apart tube sections.

9. The apparatus defined in claim 1, wherein ends of the at least one bar include a deformed and flattened side surface.

10. The apparatus defined in claim 1, wherein the at least one bar has a B-shaped cross-section.

11. The apparatus defined in claim 1, wherein the bar is made of sheet material having a material strength at least about 40 KSI tensile strength.

12. The apparatus defined in claim 11, wherein the material has a tensile strength of at least about 80 KSI.

13. The apparatus defined in claim 12, wherein the material has a tensile strength of at least about 120 KSI.

14. The apparatus defined in claim 1, wherein the at least one bar has a cross-section with total thickness dimension of at least about 2 inches.

15. The apparatus defined in claim 1, wherein the at least one bar has a cross-section with vertical height dimension of at least about 3 inches.

16. The apparatus defined in claim 1, wherein the at least one bar is longitudinally swept so as to position a middle of the bar at least about 1 inch forward of ends of the bar.

17. The apparatus defined in claim 1, wherein the at least one bar's ends are configured to releasably extend into and directly engage the side walls of the container.

18. The apparatus defined in claim 1, including brackets attached to the side walls of the container and engaging the ends of the at least one bar.

19. An energy-absorbing bulkhead apparatus for use in a shipping container, the shipping container including container side walls defining an access opening and opposing channel features, at least one door for closing the access opening, and framework on an end of the side walls adjacent the access opening, the bulkhead apparatus comprising:
a plurality of metal tubular bars with configured ends shaped to matably engage the opposing channel features, the configured ends having a first cross-sectional shape different than a second cross-sectional shape in a center of the bars, the bars being arranged horizontally between the side walls and defining a vertical plane to form a bulkhead that prevents shipped materials from unacceptably shifting into the at least one door.

20. The apparatus defined in claim 19, wherein the configured ends of each bar is formed by front and rear walls, the front and rear walls being non-parallel to each other.

21. The apparatus defined in claim 19, wherein the bars each include a swept center section.

22. The apparatus defined in claim 19, wherein the bars each define a pair of spaced-apart tubes.

23. A method of constructing an energy absorber bulkhead within a shipping container comprising:
providing a plurality of removable tubular bars, each having one of configured ends and a swept center portion; and
attaching the bars to the shipping container by placing ends of the bars into mating channel features in the side walls of the shipping container in an arrangement where the bars extend horizontally in a vertically stacked arrangement that forms a temporary structure that prevents product from unacceptably shifting against a container door

24. The method defined in claim 23, wherein the arrangement only includes bars extending horizontally to form the temporary wall.

25. A method of constructing a temporary bulkhead in a container comprising:
preforming at least one section including a structural bar of metal;
supporting ends of the at least one bar across a door-adjacent end of a container to form a bulkhead preventing product from shifting against the door during shipment;
dismantling the bulkhead; and
later reusing the at least one section in another container.

26. The method defined in claim 25, including sweeping the at least one bar so that, when positioned in a container-supported position, a center of the at least one bar is spaced away from the at least one door a greater distance than ends of the at least one bar.

27. The method defined in claim 25, including a step of attaching brackets to framework of the shipping container on each side thereof, and attaching at the least one bar to the brackets.

28. The method defined in claim 25, including rollforming the bar from sheet material of at least about 80 KSI tensile strength

29. The method defined in claim 25, including rollforming the bar to have a cross-section defining at least a pair of tubes.

30. The method defined in claim 25, including placing a flexitank within the container and, after forming the bulkhead, filling the flexitank so that an end of the flexitank presses against the bulkhead.

31. The method defined in claim 30, wherein the flexitank has a fill tube that extends through a mating hole in the bulkhead to facilitate filling and emptying the flexitank even with the presence of the bulkhead.
